(19) United States
(12) Patent Application Publication
(10) Pub. No.: US 2026/0247269 A1
(43) Pub. Date: Aug. 20, 2026

(54) TRANSMITTING EXTENDED INFORMATION TO USER EQUIPMENT (UE) IN A STANDALONE NON-PUBLIC NETWORK (SNPN)

(71) Applicant: Lenovo (Singapore) Pte. Ltd., Singapore (SG)

(72) Inventors: Roozbeh ATARIUS, La Jolla, CA (US); Genadi VELEV, Darmstadt (DE)

(21) Appl. No.: 19/157,082

(22) PCT Filed: Feb. 16, 2024
(86) PCT No.: PCT/IB2024/051458

§ 371 Date: Aug. 15, 2025

Related U.S. Application Data
(60) Provisional application No. 63/485,483, filed on Feb. 16, 2023.

(51) Int. Cl. H04W 48/18; H04W 8/08; H04W 88/06

(52) U.S. Cl. CPC H04W 48/18; H04W 8/08; H04W 88/06

(57) ABSTRACT

Various aspects of the present disclosure relate to providing a network with information about the capabilities of UEs, so the network can send extended information (e.g., extended SOR-SNPN-SI) to UEs that can handle and properly utilize such information. For example, a UE can provide its 5GMM capability information to the network during a registration procedure, and in response, the network can provide lists of SNPNs/GINs, which can include the extended information (e.g., via various container IE configurations).

### CROSS REFERENCE TO RELATED APPLICATIONS

This application claims priority to U.S. Provisional Patent Application No. 63/485,483, filed on Feb. 16, 2023, entitled TRANSMITTING EXTENDED INFORMATION TO USER EQUIPMENT (UE) IN A STANDALONE NON-PUBLIC NETWORK (SNPN), which is hereby incorporated by reference in its entirety.

### TECHNICAL FIELD

The present disclosure relates to wireless communications, and more specifically to communications between user equipment (UE) and a Standalone Non-Public Network (SNPN).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A Non-Public Network (NPN) facilitates the deploying of the 5G access technology for private uses or environments, such as a network dedicated to a single organization. One type of NPN is an SNPN, which is operated by an NPN operator and provides its own network functions without utilizing network functions provided by a PLMN, or Public Land Mobile Network.

### SUMMARY

The present disclosure relates to methods, apparatuses, and systems that support providing a network with information about the capabilities of UEs, so the network can send extended information (e.g., extended steering of roaming standalone non-public network selection information, or SOR-SNPN-SI) to UEs that can handle and properly utilize such information. For example, a UE can provide its 5GMM capability information to the network during a registration procedure, and in response, the network can provide lists of SNPNs and/or Group Identity for Networks (GINs), which can include the extended information (e.g., via various container information element (IE) configurations).

Some implementations of the method and apparatuses described herein may further include a UE comprising at least one memory and at least one processor coupled with the at least one memory and configured to cause the UE to transmit, to a network function, an indication that the UE supports extended SOR-SNPN-SI and receive, from the network function, a list of SNPNs and/or GINs that support extended SOR-SNPN-SI.

In some implementations of the method and apparatuses described herein, the UE transmits the indication via a registration request message sent during an initiated registration procedure.

In some implementations of the method and apparatuses described herein, the UE receives the list of SNPSs and/or GINs via a registration acceptance message.

In some implementations of the method and apparatuses described herein, the indication is a bit in an 5GMM capability information element.

In some implementations of the method and apparatuses described herein, the UE transmits a second indication that the UE supports extended SOR-SNPN-SI to confirm reception of the list of SNPNs and/or GINs via a registration complete message.

In some implementations of the method and apparatuses described herein, the second indication is a bit in an SOR transparent container information element.

In some implementations of the method and apparatuses described herein, the processor is further configured to cause the UE to receive a request from the network function to confirm receipt of the list of SNPNs and/or GINs that support extended SOR-SNPN-SI and transmit confirmation of the list to the network function.

In some implementations of the method and apparatuses described herein, the UE confirms receipt of the list of SNPNs and/or GINs that support extended SOR-SNPN-SI by transmitting its capability to receive the list of SNPNs and/or GINs that support extended SOR-SNPN-SI.

In some implementations of the method and apparatuses described herein, the indication includes an indication that the UE supports validity time information and/or validity area information for an SNPN and/or GIN.

Some implementations of the method and apparatuses described herein may further include a processor for wireless communication, comprising at least one controller coupled with at least one memory and configured to cause the processor to transmit, to a network function, an indication that the processor supports extended steering of roaming SOR-SNPN-SI and receive, from the network function, a list of SNPNs and/or GINs that support extended SOR-SNPN-SI.

Some implementations of the method and apparatuses described herein may further include a method performed by a UE, the method comprising transmitting, to a network function, an indication that the UE supports extended SOR-SNPN-SI and receiving, from the network function, a list of SNPNs and/or GINs that support extended SOR-SNPN-SI.

In some implementations of the method and apparatuses described herein, the UE transmits the indication via a registration request message sent during an initiated registration procedure.

In some implementations of the method and apparatuses described herein, the UE receives the list of SNPSs and/or GINs via a registration acceptance message.

In some implementations of the method and apparatuses described herein, the UE transmits a second indication that the UE supports extended SOR-SNPN-SI to confirm reception of the list of SNPSs and/or GINs via a registration complete message.

In some implementations of the method and apparatuses described herein, the second indication is a bit in an SOR transparent container information element.

In some implementations of the method and apparatuses described herein, the indication is a bit in an 5GMM capability information element.

In some implementations of the method and apparatuses described herein, the UE receives a request from the network function to confirm receipt of the list of SNPNs and/or GINs that support extended SOR-SNPN-SI and transmits confirmation of the list to the network function.

In some implementations of the method and apparatuses described herein, the UE confirms receipt of the list of SNPNs and/or GINs that support extended SOR-SNPN-SI by transmitting its capability to receive the list of SNPNs and/or GINs that support extended SOR-SNPN-SI.

In some implementations of the method and apparatuses described herein, the indication includes an indication that the UE supports validity time information and/or validity area information for an SNPN and/or GIN.

Some implementations of the method and apparatuses described herein may further include a network function, comprising at least one memory and at least one processor coupled with the at least one memory and configured to cause the network function to determine whether to transmit extended SOR-SNPN-SI for SNPNs and/or GINs that support extended SOR-SNPN-SI to a UE and transmit a list of SNPNs and/or GINs to the UE based on the determination.

In some implementations of the method and apparatuses described herein, the processor is configured to cause the network function to determine whether to transmit the extended SOR-SNPN-SI for the SNPNs and/or GINs based on user subscription information associated with the UE for localized services provided by the SNPNs and/or GINs and UE capability information for receiving the list of SNPNs and/or GINs that support the extended SOR-SNPN-SI.

In some implementations of the method and apparatuses described herein, the localized services are identified by time validity information and/or location validity information within the extended SOR-SNPN-SI.

In some implementations of the method and apparatuses described herein, the UE capability information is received via a registration message sent by the UE to the network function during an initial registration procedure.

In some implementations of the method and apparatuses described herein, the network function transmits the list of the SNPNs and/or GINs to the UE via a network entity, wherein the network entity is an Access and Mobility Management Function (AMF) and uses an SOR transparent container information element in a registration accept message or a downlink (DL) Non-Access-Stratum (NAS) transport message.

In some implementations of the method and apparatuses described herein, the processor is further configured to cause the network function to transmit a request of an acknowledgement for receipt of the list of the SNPNs and/or GINs from the UE, wherein the network function receives the information via a network entity, and wherein the network entity is an AMF and receives capability information for the UE for reception of the list of the SNPNs and/or GINs via an SOR transparent container information element in a registration complete message or a UL NAS transport message.

In some implementations of the method and apparatuses described herein, the network function is a Unified Data Management (UDM) function.

In some implementations of the method and apparatuses described herein, the network function transmits to a Steering of Roaming Application Function (SOR-AF) a request for creating a SOR transparent container, wherein the request includes the UE capability information and the UE subscription information for the localized services.

Some implementations of the method and apparatuses described herein may further include a method performed by a network function, the method comprising determining whether to transmit extended SOR-SNPN-SI for SNPNs and/or GINs that support extended SOR-SNPN-SI to a UE and transmitting a list of SNPNs and/or GINs to the UE based on the determination.

In some implementations of the method and apparatuses described herein, the determining whether to transmit the extended SOR-SNPN-SI for the SNPNs and/or GINs is based on user subscription information associated with the UE for localized services provided by the SNPNs and/or GINs and UE capability information for receiving the list of SNPNs and/or GINs that support the extended SOR-SNPN-SI.

In some implementations of the method and apparatuses described herein, the localized services are identified by time validity information and/or location validity information within the extended SOR-SNPN-SI.

In some implementations of the method and apparatuses described herein, the UE capability information is received via a registration message sent by the UE to the network function during an initial registration procedure.

In some implementations of the method and apparatuses described herein, the network function transmits the list of the SNPNs and/or GINs to the UE via an SOR transparent container information element in a registration accept message or a downlink (DL) NAS transport message.

In some implementations of the method and apparatuses described herein, the method includes transmitting a request of an acknowledgement for receipt of the list of the SNPNs and/or GINs from the UE, wherein the network function receives the information via a network entity, and wherein the network entity is an AMF and receives capability information for the UE for reception of the list of the SNPNs and/or GINs via an SOR transparent container information element in a registration complete message or a UL NAS transport message.

In some implementations of the method and apparatuses described herein, the network function is a UDM function.

In some implementations of the method and apparatuses described herein, the network function transmits to an SOR-AF a request for creating a SOR transparent container, wherein the request includes the UE capability information and the UE subscription information for the localized services.

### BRIEF DESCRIPTION OF THE DRAWINGS

FIG. 1 illustrates an example of a wireless communications system that supports communications between UEs and an SNPN in accordance with aspects of the present disclosure.

FIG. 2 illustrates an example of a diagram that supports providing extended information to a UE during a registration procedure in accordance with aspects of the present disclosure.

FIG. 3 illustrates an example of a diagram that supports a 5GMM capability information element modified with extended information in accordance with aspects of the present disclosure.

FIGS. 4A-4B illustrate examples of diagrams that support 5GMM capability information elements modified with extended information in accordance with aspects of the present disclosure.

FIG. 5 illustrates an example of a diagram that supports a 5GMM capability information element modified only with extended information in accordance with aspects of the present disclosure.

FIG. 6 illustrates an example of a diagram that supports extended information acknowledgment information in accordance with aspects of the present disclosure.

FIGS. 7A-7B illustrate examples of diagrams that support SOR headers having extended information in accordance with aspects of the present disclosure.

FIG. 8 illustrates an example of a block diagram of a device that supports communications between a UE and an SNPN in accordance with aspects of the present disclosure.

FIG. 9 illustrates a flowchart of a method that supports communicating UE capability information to a network in accordance with aspects of the present disclosure.

FIG. 10 illustrates a flowchart of a method that supports providing a UE with extended information in accordance with aspects of the present disclosure.

### DETAILED DESCRIPTION

An SOR transparent container information element (as defined in 3GPP TS 24.501) is used for communications between a UE and a UDM. For example, the UDM can utilize the SOR transparent container IE to transmit:

A channel (CH) controlled prioritized list of preferred SNPNs, where the SNPNs are listed by their identities and in the order with respect to their priorities by the first listed SNPN having the highest priority among all the listed SNPNs; and/or

A CH controlled prioritized list of GINs, where the GINs are listed by their identities and in the order with respect to their priorities by the first listed GIN having the highest priority among all the listed GINs; and so on.

When the UE supports a capability to receive the list of the CH controlled prioritized list of preferred SNPNs and/or CH controlled prioritized list of GINs, the network transmits the SOR transparent container IE in a Payload container information element, such as within a REGISTRATION ACCEPT message during a registration procedure from the UE to the 5GS network.

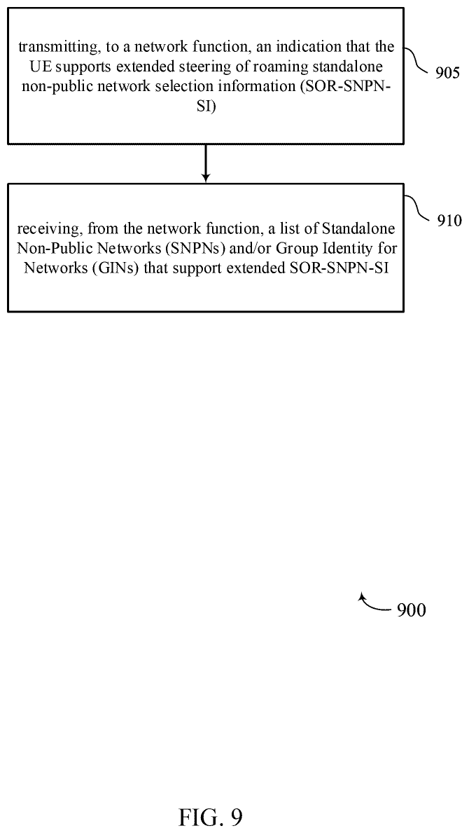

The IE can include SOR-SNPN-SI (as shown in FIG. 9.11.3.51.2A of 3GPP TS 24.501). The SOR-SNPN-SI, in some cases, contains information for the CH controlled prioritized list of preferred SNPNs and CH controlled prioritized list of GINs.

Thus, while SOR-SNPN-SI includes some information, its current configuration may contain only the identities of the SNPNs/GINs and may not include other parameters/features associated with the SNPNs/GINs, such as validity area features and/or time of day features. In some cases, the network may modify the SOR-SNPN-SI to include new lists that contain the CH controlled prioritized list of preferred SNPNs, the CH controlled prioritized list of GINs, as well as new features, such as validity area and/or time of day information.

Such a configuration, therefore, utilizing an extended SOP-SNPN-SI, can enable a network to transmit information about additional features (e.g., validity area and time of day for the CH controlled prioritized list of preferred SNPNs and CH controlled prioritized list of GINs).

The configuration includes indicators, such as a credential holder (CH) controlled prioritized list of preferred SNPNs indicator (CLSI) and a CH controlled prioritized list of GINs indicator (CLGI). Thus, the network has no indication as to what UEs can utilize extended information, and, therefore, what UEs should be sent extended information, such as extended SOP-SNPN-SI during registration or other procedures.

The technology described herein addresses these and other problems by providing a network with information about the capabilities of UEs, so the network can send extended information (e.g., extended SOR-SNPN-SI) to UEs that can handle and properly utilize such information. For example, a UE can provide its 5GMM capability information to the network during a registration procedure, and in response, the network can provide lists of SNPNs/GINs, which can include the extended information (e.g., via various container IE configurations).

Thus, in various embodiments, the technology described herein enables a network to efficiently provide information, such as extended information for an available SPNN and/or GIN, to a UE that is attempting to connect to an SNPN/GIN for localized services or other communications, among other benefits.

Aspects of the present disclosure are described in the context of a wireless communications system. Aspects of the present disclosure are further illustrated and described with reference to device diagrams and flowcharts.

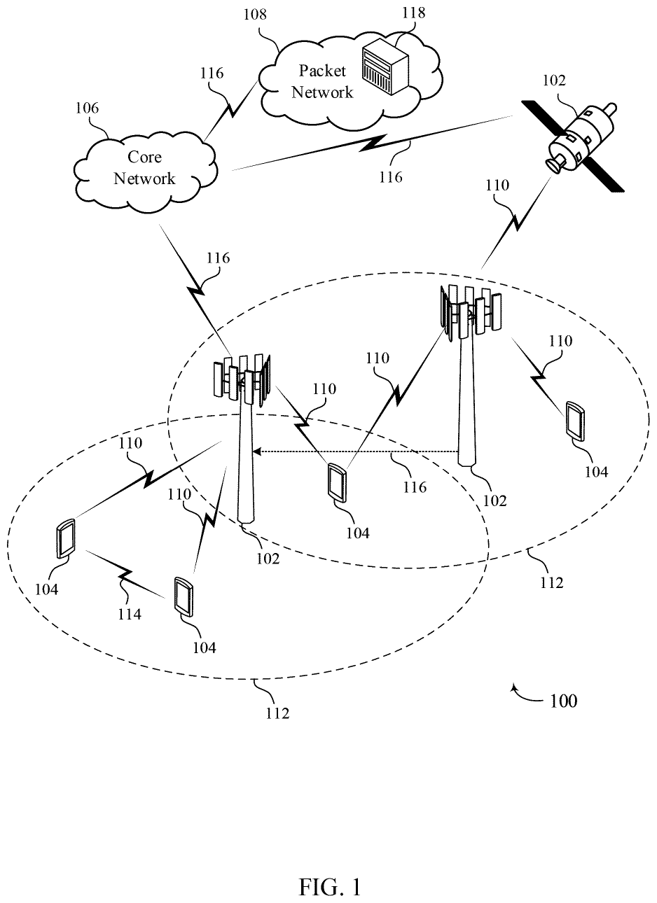

FIG. 1 illustrates an example of a wireless communications system 100 that supports communications between UEs and an SNPN in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUsor RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FRI may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some embodiments, the technology described herein enables a network to efficiently provide information, such as extended information for an available SPNN and/or GIN, to a UE that is attempting to connect to an SNPN/GIN for localized services or other communications. When a UE (e.g., the UE 104) includes new or updated capabilities, such as capabilities to receive and process extended information (e.g., validity time and/or validity area for an SNPN/GIN), the UE can transmit its capabilities to the network in a Non-Access Stratum (NAS) procedure (e.g., during a registration request procedure). In response, the network can transmit a list that includes a CH controlled prioritized list of preferred SNPNs and/or a CH controlled prioritized list of GINs. The list can include extended information, such as new information for validity area and time of day for the SNPNs/GINs.

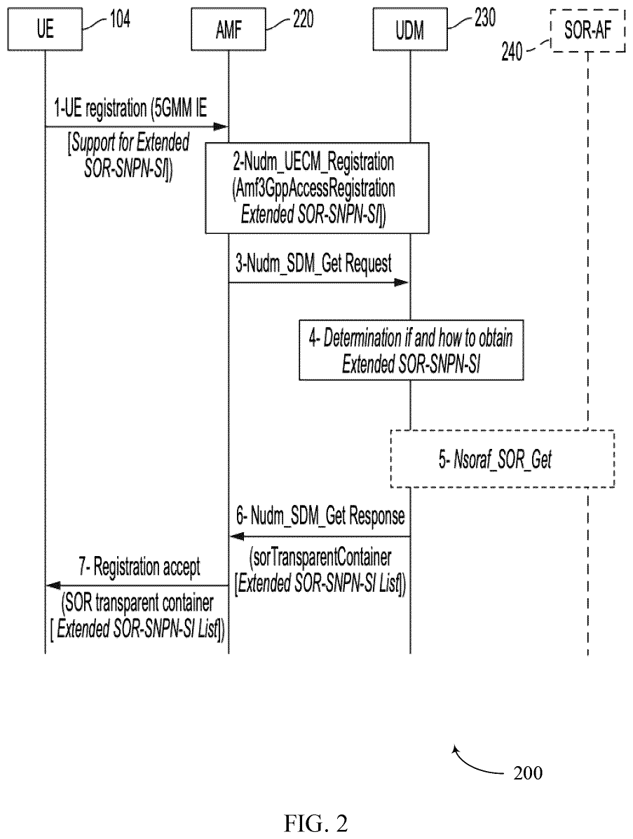

FIG. 2 illustrates an example of a diagram 200 that supports providing extended information to a UE during a registration procedure in accordance with aspects of the present disclosure. For example, the UE 104 performs a registration procedure with a 5G core network, which can include an Access and Mobility Management Function (AMF) 220, a Unified Data Management (UDM) function 230, and a Steering of Roaming Application Function (SOR-AF) 240. The registration procedure can include the following steps:
Step 1: The UE 104 initiates a registration procedure by sending a REGISTRATION REQUEST message to the AMF 220. The UE 104 includes 5GMM capability information with the UE's capabilities in the REGISTRATION REQUEST message.

In order for the UE 104 to indicate its support for extended SOR-SNPN-SI, the UE 104 uses a new indication (e.g., a new bit) in a 5GMM capability information element, which may be identified by the name E-SSNPNSI and which may be bit 3 of octet 8 of the 5GMM capability information element.

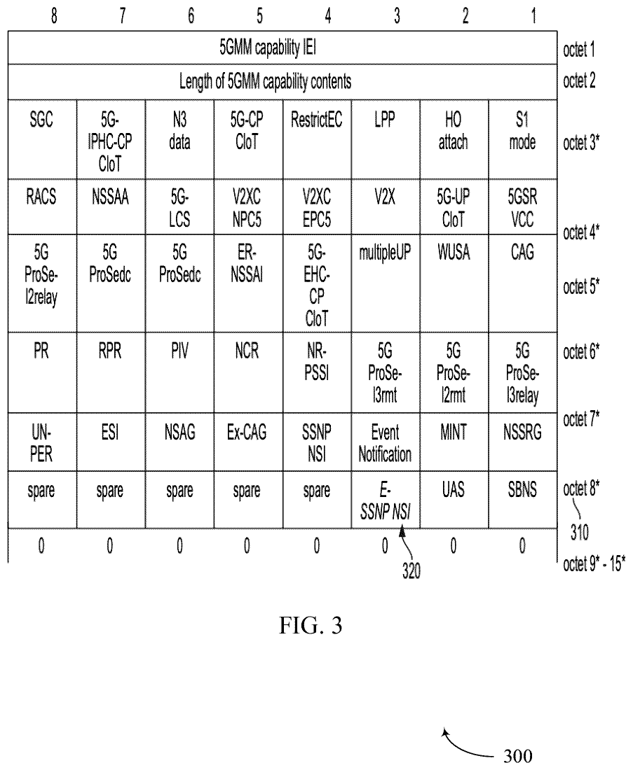

FIG. 3 illustrates an example of a diagram that supports a 5GMM capability information element 300 modified with extended information in accordance with aspects of the present disclosure. As depicted, an octet 310 (e.g., octet 8) can include E-SSNPNSI information in a spare bit 320 (e.g., bit 3), which indicates the capabilities of the UE 104. For example, when the bit 320, or “E-SSNPSI,” is set to zero, then extended SOR-SNPN-SI is not supported by the UE 104, and when the bit 320, or “E-SSNPSI,” is set to one, then extended SOR-SNPN-SI is supported by the UE 104.

In some cases, the extended SOR-SNPN-SI refers to the CH controlled prioritized list of preferred SNPNs with validity area and time of day and/or the CH controlled prioritized list of preferred GINs with validity area and time of day.

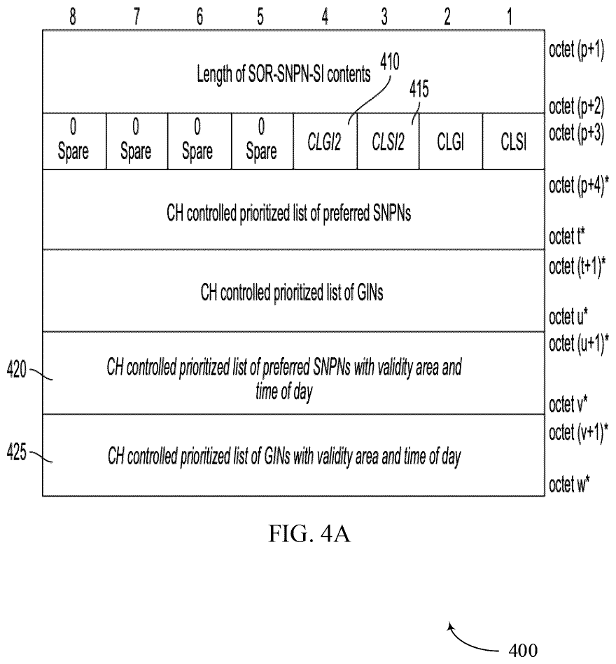

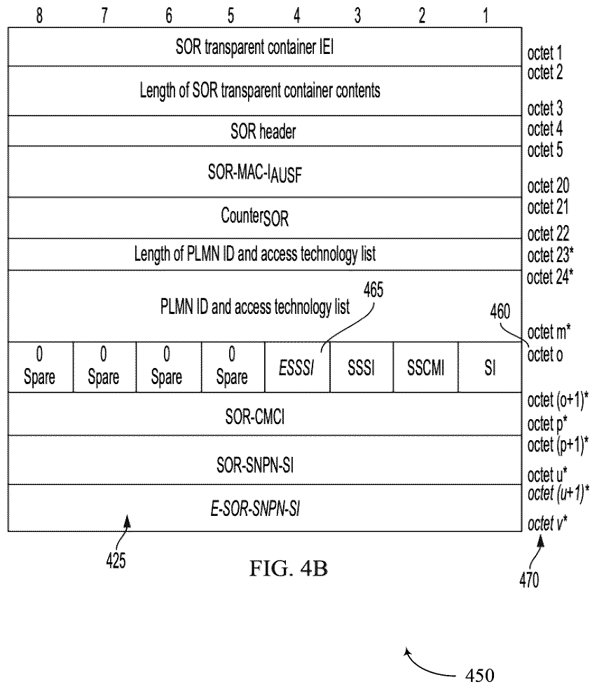

Returning to FIG. 2, Step 2 is as follows: Similar to message 14a in FIG. 4.2.2.2.2-1 of 3GPP TS 23.502, the AMF 220 registers with the UDM 230 using Nudm UECM Registration for the access to be registered. The AMF 220 also subscribes to be notified when/if the UDM 230 deregisters it. During the Nudm_UECM_Registration the AMF 220 sends a HTTP PUT request to the UDM 230 to update the AMF registration information for 3GPP access. The resource name for the HTTP PUT request is Amf3GppAccessRegistration and resource URI is /{ueId}/registrations/amf-3gpp-access, see 3GPP TS 29.503.

In some cases, the data type of Amf3GppAccessRegistration may contain a new optional attribute (e.g., “ESorSnpnSiSupported” of data type Boolean), which carries the information as to whether the UE 104 supports receiving the capability of the UE or ME to support receiving the information for the CH controlled prioritized list of preferred SNPNs with validity area and time of day and/or the CH controlled prioritized list of preferred GINs with validity area and time of day (Extended SOR-SNPN-SI). For example, the attribute “E-SorSnpnSiSupported” is set to true then extended SOR-SNPN-SI is supported and is set to false or absent when extended SOR-SNPN-SI is not supported.
Step 3: After the AMF 220 has successfully completed the Nudm_UECM_Registration operation, the AMF 220 retrieves the Access and Mobility Subscription data, SMF Selection Subscription data, UE context in SMF data and LCS mobile origination by using Nudm_SDM_Get as HTTP GET request with resource name AccessAndMobility SubscriptionData and resource URI /{supi} /am-data (see 3GPP TS 29.503).
Step 4: The UDM 230 determines whether to transmit the extended SOR-SNPN-SI (e.g., E-SOR-SNPN-SI) by utilizing (1) user subscription information (e.g., whether the user subscription allows the UE 104 to use localized services, where the localized services are identified by time validity and/or location validity information within a list of available SNPNs/GINs), and (2) UE capability information (e.g., received in step 1) to receive the information element containing the extended SOR for the list of SNPNs/GINs (E-SOR-SNPN-SI).

Thus, the UDM 230 can determine whether the UE 104 is to receive extended SOR-SNPN-SI based on a determination that the UE 104 is a subscriber of localized services (or is associated with a user that subscribes to the localized services) and has provided information that indicates the UE 104 can utilize extended SOR-SNPN-SI sent by the AMF 220 or UDM 230.

In other words, the UDM (or together with the SOR-AF 240 in step 5) may create an SOR container after having received the UE capability and subscription information for localized services. The SOR container can include at least two new types of CH controlled prioritized list of preferred network IDs. One type may be called “CH controlled prioritized list of preferred SNPNs with validity criteria” and the other type may be called “CH controlled prioritized list of GINs with validity criteria.” The validity criteria can be at least one of: validity area or validity time.
Step 5: If the subscribed SNPN/HPLMN has policy for SOR-AF invocation, then the UDM 230 requests the SOR-AF 240 to provide the steering of roaming information. The UDM 230 may further indicate the UE capability to support E-SOR-SNPN-SI (e.g., as received in step 3) and the UE's subscription for the localized services. Based on the request and the additional indictions from the UDM 230, the SOR-AF 240 may create and provide to the UDM 230 the E-SOR-SNPN-SI. The step 5 may use the procedure in 3GPP TS 29.571.
Step 6: The UDM 230 sends HTTP 200 OK containing the UE's subscribed Access and Mobility Data. The data type AccessAndMobility SubscriptionData contains the attribute “sorInfo” of type SorInfo, which is used by the UDM 230 to send the extended SOR-SNPN-SI. The optional attribute “sorInfo” may be “sorTransparentContainer,” and is encoded as SOR transparent container information element (e.g., specified in clause 9.11.3.51 of 3GPP TS 24.501). The SOR transparent container information element contains the extended SOR-SNPN-SI. As described herein, the data type SorInfo can also include the attribute “ackInd,” which is used as an indication that the UDM 230 requests an acknowledgement from the UE 104 as part of the steering of roaming information.
Step 7: The AMF 220 transparently sends the received extended steering of roaming information to the UE 104 via a REGISTRATION ACCEPT message (e.g., as shown in message 21 of FIG. 4.2.2.2.2-1 of 3GPP TS 23.502). FIG. 4A illustrates an example of a diagram 400 that supports a 5GMM capability information element modified with extended information in accordance with aspects of the present disclosure. The E-SOR-SNPN-SI can include a CLGI indicator 410 and/or a CLSI indictor 415. Further, the extended information can include a CH controlled prioritized list of preferred SNPNs with validity area and time of day 420 and a CH controlled prioritized list of GINs with validity area and time of day 425.

In some cases, the SOR-SNPN-SI indicator (e.g., SSSI), which is bit 3 in octet o in FIG. 9.11.3.51.2A of 3GPP TS 24.501, can also be used for indicating the availability of the E-SOR-SNPN-SI information.

FIG. 4B illustrates an example of a diagram 450 that supports a 5GMM capability information element modified with extended information in accordance with aspects of the present disclosure. The IE can include, for example, ESSSI 465 in a spare bit of octet o 460. As another example, the IE can include either SOR-SNPN-SI or E-SOR-SNPN-SI, but not both together. If the UDM 230 has rules without extended information, such as validity area and/or validity time, then the values for the extended information should indicate that those values are missing. Thus, octet v 470 can include the E-SOR-SNPN-SI 475, but not the SOR-SNPN-SI.

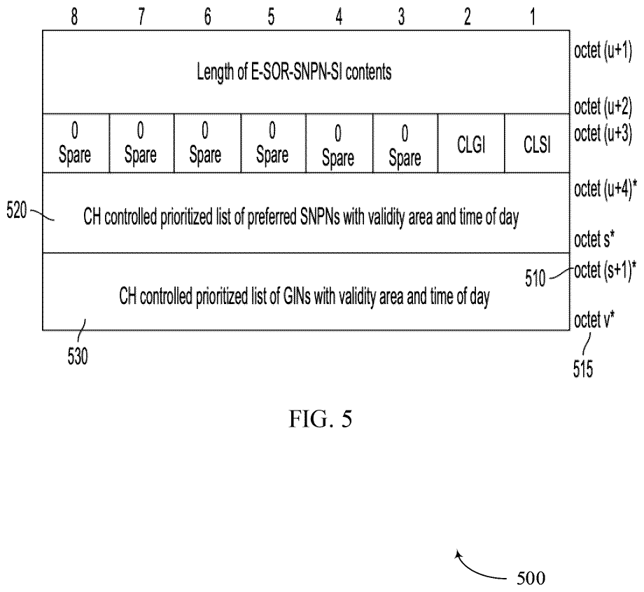

In some cases, the SOR transparent container information element can include both SOR-SNPN-SI and E-SOR-SNPN-SI. FIG. 5 illustrates an example of a diagram 500 that supports a 5GMM capability information element modified only with extended information in accordance with aspects of the present disclosure. The IE only includes information for the E-SOR-SNPN-SI.

For example, octet (s+1)* 510 includes the addition feature information of the CH controlled prioritized list of preferred SNPNs with validity area and time of day information 520, and octet v* 515 includes the addition feature information of the CH controlled prioritized list of GINs with validity area and time of day information 530.

In some embodiments, the technology can include a procedure for acknowledging receipt or use of the extended SOR-SNPN-SI. During such a procedure, step 3 through step 10 may be executed due to either registration or a change of E-SOR-SNPN-SI that the UE 104 is required to be provided with new rules. In such cases, the UDM knows and stores information that indicates that the UE 104 supports receiving the E-SOR-SNPN-SI, such as during the initial registration. If step 3 thru step 7 are executed due to a change of E-SOR-SNPN-SI, the change may be invoked by the SOR-AF 240, such as when then HPLMN/SNPN has a policy for the SOR-AF invocation in the UDM 230.

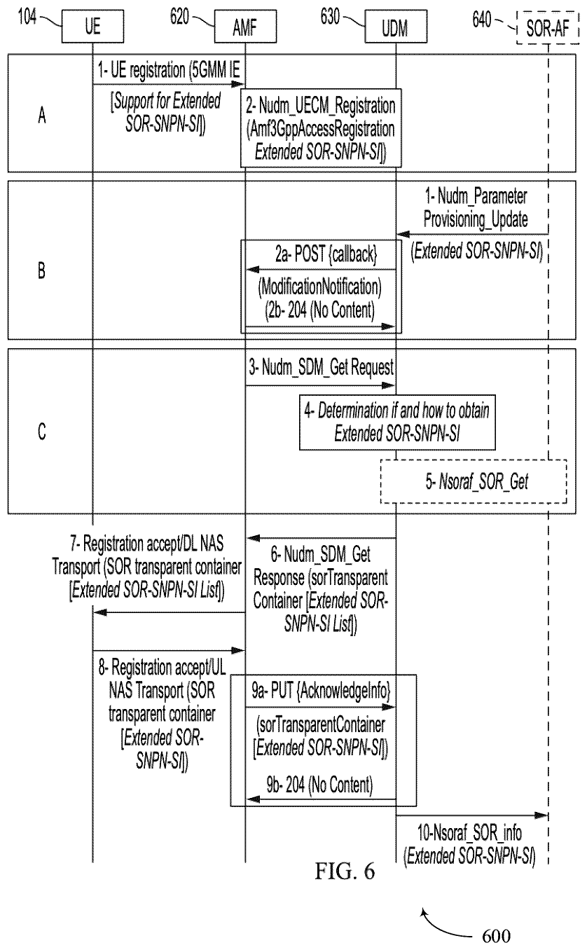

FIG. 6 illustrates an example of a diagram 600 that supports extended information acknowledgment information in accordance with aspects of the present disclosure. As shown, case A refers to a registration procedure between the UE 104, an AMF 620, and a UDM 630 (similar to the procedure in FIG. 2), and case B reflects the rules updates (e.g., between the UDM 630 and an SOR-AF 640, also shown in FIG. 2).

For example, following case B, the SOR-AF 640 sends an Nudm ParameterProvision_Update to the UDM 630 to trigger the update of the UE 104 with the E-SOR-SNPN-SI. Then, the UDM 630 notifies the changes of the information related to the UE 105 to the affected AMF 620 by sending a POST request comprising a callbackReference URI as previously received in a SdmSubscription during the subscription and the subscription identity e.g., see 3GPP TS 29.503).

Starting at step 6: (Similar to step 6 of FIG. 2), an indication is included by the UDM 630 to request an acknowledgement from the UE 104 as part of the steering of roaming information by using attribute “ackInd.”
Step 7: Depending if the procedure is initiated by initial registration or as an update for E-SOR-SNPN-SI, the AMF 620 uses the REGISTRATION ACCEPT message or a DL NAS TRANSPORT message to convey the information for E-SOR-SNPN-SI to the UE 104.

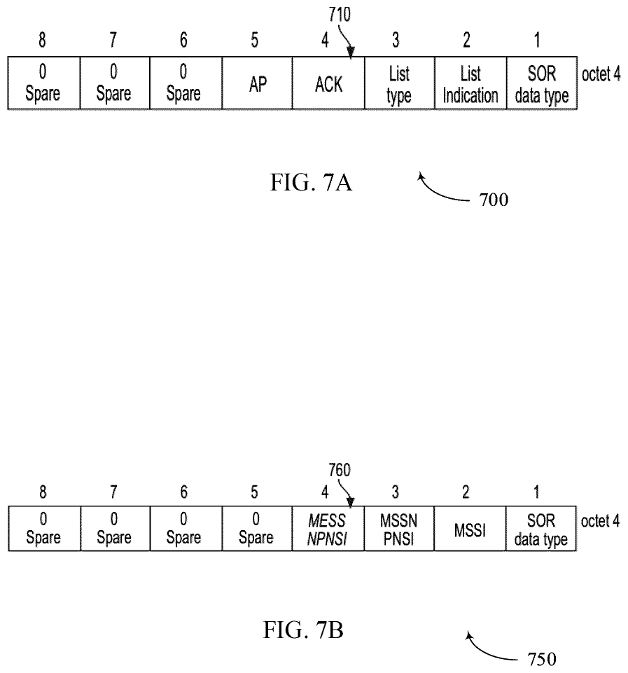

FIG. 7A illustrates an example of a diagram 700 that supports an SOR header having extended information in accordance with aspects of the present disclosure. As shown, the AMF 620 can set an ACK 710 (e.g., in FIG. 9.11.3.51.5 of 3GPP TS 24.501) to value “1,” to indicate to the UR 104 that the network requests an acknowledgement from the UE 104.
Step 8: If the procedure is initiated by an initial registration or as an update for E-SOR-SNPN-SI, the UE 104 includes in the REGISTRATION COMPLETE message or UL NAS TRANSPORT message an SOR transparent container information element. The SOR transparent container IE can include an SOR header for SOR transparent container carrying acknowledgement of successful reception of the extended steering of roaming information (see FIG. 7A).

In some cases, when the SOR-SNPN-SI and the extended E-SOR-SNPN-SI cannot be transmitted to the UE 104 at the same time, the device/UE 104 may use the same indicator MSSNPNSI in the SOR header. The network then knows the information the acknowledgement refers to.

In some cases, the the SOR header includes a new indicator to show the device/UE support of E-SOR-SNPN-SI. FIG. 7B illustrates an example of a diagram 750 that supports an SOR header having a new indicator in accordance with aspects of the present disclosure. As shown, the SOR header can include a new indicator 760, such as a MSSNPNSI value in octet 4, bit 4), to indicate the acknowledgement by the UE 104. For example, MESSNPNSI can be set to “1” if the E-SOR-SNPN-SI is supported by the device/UE and set to “0” if E-SOR-SNPN-SI is not supported by the device/UE.
Step 9: The AMF 620 sends the acknowledgment towards the UDM 630 by sending a PUT request comprising the AcknowledgeInfo of successful reception of the extended steering of roaming information (e.g., see 3GPP TS 29.503).
Step 10: If the subscribed SNPN or HPLMN policy for the SOR-AF 640 invocation is present and the UDM 630 received and verified the UE acknowledgement in step 9, then the UDM 630 informs the SOR-AF 640 about successful delivery of the E-SOR-SNPN-SI.

In some embodiments, the technology described herein can apply similar messaging (as shown in FIG. 2 or FIG. 6) to a non-3GPP access network, where the UE 104 utilizes the non-3GPP access network to register to a 5GS.

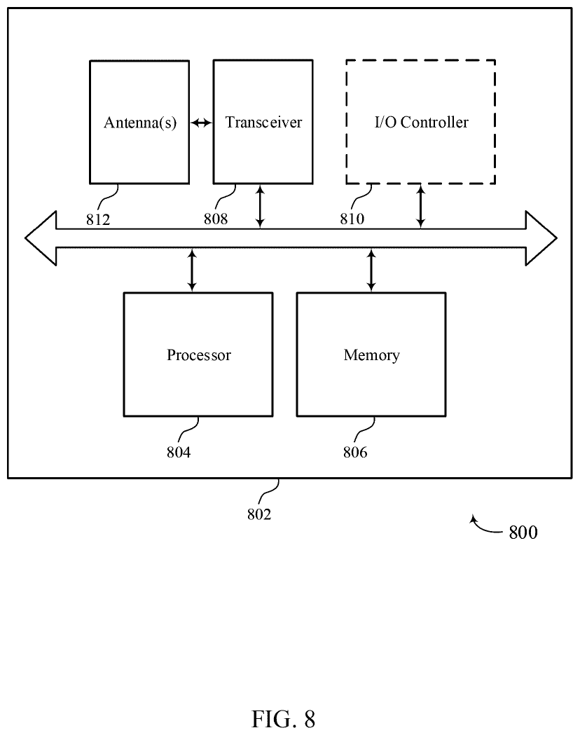

FIG. 8 illustrates an example of a block diagram 800 of a device 802 that supports communications between a UE and an SNPN in accordance with aspects of the present disclosure. The device 802 may be an example of a network entity 102 or UE 104 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. The processor 804 may be configured as or otherwise support a means for determining whether to transmit extended SOR-SNPN-SI for SNPNs and/or GINs that support extended SOR-SNPN-SI to a UE and transmitting a list of SNPNs and/or GINs to the UE based on the determination.

As another example, the processor 804 may support wireless communication at the device 802 in accordance with examples as disclosed herein. The processor 804 may be configured as or otherwise support a means for transmitting, to a network function, an indication that the UE supports extended SOR-SNPN-SI, and receiving, from the network function, a list of SNPNs and/or GINs that support extended SOR-SNPN-SI.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor M06. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

FIG. 9 illustrates a flowchart of a method 900 that supports communicating UE capability information to a network in accordance with aspects of the present disclosure. The operations of the method 900 may be implemented by a device or its components as described herein. For example, the operations of the method 900 may be performed by the UE 104 as described with reference to FIGS. 1 through 7B. In some implementations, the device may execute a set of instructions to control the function elements of the device to perform the described functions. Additionally, or alternatively, the device may perform aspects of the described functions using special-purpose hardware.

At 905, the method may include transmitting, to a network function, an indication that the UE supports extended SOR-SNPN-SI. The operations of 905 may be performed in accordance with examples as described herein. In some implementations, aspects of the operations of 905 may be performed by a device as described with reference to FIG. 1.

At 910, the method may include receiving, from the network function, a list of SNPNs and/or GINs that support extended SOR-SNPN-SI. The operations of 910 may be performed in accordance with examples as described herein. In some implementations, aspects of the operations of 910 may be performed by a device as described with reference to FIG. 1.

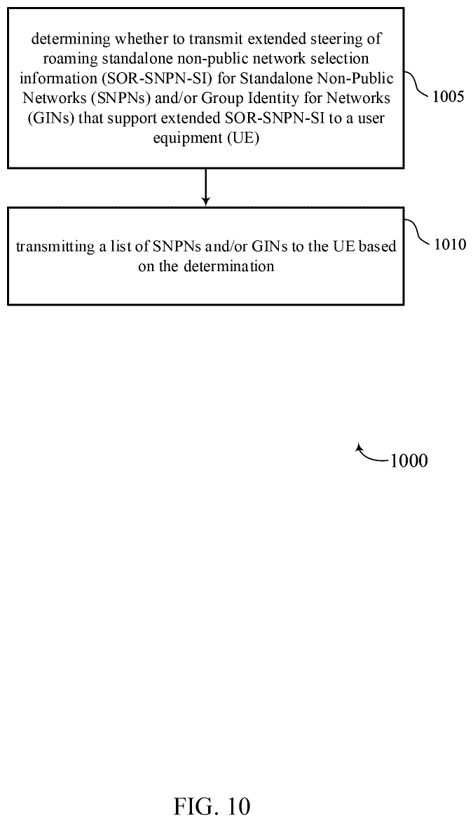

FIG. 10 illustrates a flowchart of a method 1000 that supports providing a UE with extended information in accordance with aspects of the present disclosure. The operations of the method 1000 may be implemented by a device or its components as described herein. For example, the operations of the method 1000 may be performed by the network, cell, or network entity as described with reference to FIGS. 1 through 7B. In some implementations, the device may execute a set of instructions to control the function elements of the device to perform the described functions. Additionally, or alternatively, the device may perform aspects of the described functions using special-purpose hardware.

At 1005, the method may include determining whether to transmit extended SOR-SNPN-SI for SNPNs and/or GINs that support extended SOR-SNPN-SI to a UE. The operations of 1005 may be performed in accordance with examples as described herein. In some implementations, aspects of the operations of 1005 may be performed by a device as described with reference to FIG. 1.

At 1010, the method may include transmitting a list of SNPNs and/or GINs to the UE based on the determination. The operations of 1010 may be performed in accordance with examples as described herein. In some implementations, aspects of the operations of 1010 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
transmit, to a network function, an indication that the UE supports extended steering of roaming standalone non-public network selection information (SOR-SNPN-SI); and
receive, from the network function, a list of Standalone Non-Public Networks (SNPNs) and/or Group Identity for Networks (GINs) that support extended SOR-SNPN-SI.

2. The UE of claim 1, wherein the UE transmits the indication via a registration request message sent during an initiated registration procedure.

3. The UE of claim 1, wherein the UE receives the list of SNPNs and/or GINs via a registration acceptance message.

4. The UE of claim 1, wherein the indication is a bit in an 5GMM capability information element.

5. The UE of claim 1, wherein the UE transmits a second indication that the UE supports extended SOR-SNPN-SI to confirm reception of the list of SNPNs and/or GINs via a registration complete message.

6. The UE of claim 5, wherein the second indication is a bit in an SOR transparent container information element.

7. The UE of claim 1, wherein the at least one processor is further configured to cause the UE to:
receive a request from the network function to confirm receipt of the list of SNPNs and/or GINs that support extended SOR-SNPN-SI; and
transmit confirmation of the list to the network function.

8. The UE of claim 7, wherein the UE confirms receipt of the list of SNPNs and/or GINs that support extended SOR-SNPN-SI by transmitting its capability to receive the list of SNPNs and/or GINs that support extended SOR-SNPN-SI.

9. The UE of claim 1, wherein the indication includes an indication that the UE supports validity time information and/or validity area information for an SNPN and/or GIN.

10. A processor for wireless communication, comprising:
at least one controller coupled with at least one memory and configured to cause the processor to:
transmit, to a network function, an indication that the processor supports extended steering of roaming standalone non-public network selection information (SOR-SNPN-SI); and
receive, from the network function, a list of Standalone Non-Public Networks (SNPNs) and/or Group Identity for Networks (GINs) that support extended SOR-SNPN-SI.

11. The processor of claim 10, wherein the processor transmits the indication via a registration request message sent during an initiated registration procedure.

12. A method performed by a user equipment (UE), the method comprising:
transmitting, to a network function, an indication that the UE supports extended steering of roaming standalone non-public network selection information (SOR-SNPN-SI); and
receiving, from the network function, a list of Standalone Non-Public Networks (SNPNs) and/or Group Identity for Networks (GINs) that support extended SOR-SNPN-SI.

13. A network function for wireless communication, comprising:
at least one memory; and
at least one processor coupled with the at least one memory and configured to cause the network function to:
determine whether to transmit extended steering of roaming standalone non-public network selection information (SOR-SNPN-SI) for Standalone Non-Public Networks (SNPNs) and/or Group Identity for Networks (GINs) that support extended SOR-SNPN-SI to a user equipment (UE); and
transmit a list of SNPNs and/or GINs to the UE based on the determination.

14. The network function of claim 13, wherein the at least one processor is configured to cause the network function to determine whether to transmit the extended SOR-SNPN-SI for the SNPNs and/or GINs based on:
user subscription information associated with the UE for localized services provided by the SNPNs and/or GINs; and
UE capability information for receiving the list of SNPNs and/or GINs that support the extended SOR-SNPN-SI.

15. The network function of claim 14, wherein the localized services are identified by time validity information and/or location validity information within the extended SOR-SNPN-SI.

16. The network function of claim 14, wherein the UE capability information is received via a registration message sent by the UE to the network function during an initial registration procedure.

17. The network function of claim 13, wherein the network function transmits the list of the SNPNs and/or GINs to the UE via a network entity,
wherein the network entity is an Access and Mobility Management Function (AMF) and uses an SOR transparent container information element in a registration accept message or a downlink (DL) Non-Access-Stratum (NAS) transport message.

18. The network function of claim 13, wherein the at least one processor is further configured to cause the network function to:
transmit a request of an acknowledgement for receipt of the list of the SNPNs and/or GINs from the UE,
wherein the network function receives the information via a network entity,
wherein the network entity is an Access and Mobility Management Function (AMF) and receives capability information for the UE for reception of the list of the SNPNs and/or GINs via an SOR transparent container information element in a registration complete message or an uplink (UL) Non-Access-Stratum (NAS) transport message.

19. The network function of claim 13, wherein the network function is a Unified Data Management (UDM) function.

20. The network function of claim 13, wherein the network function transmits to a Steering of Roaming Application Function (SOR-AF) a request for creating a SOR transparent container, wherein the request includes UE capability information and the-UE subscription information for localized services.
